(19) United States
(12) Patent Application Publication
(10) Pub. No.: US 2023/0148637 A1
(43) Pub. Date: May 18, 2023

(54) RAW CHINESE NOODLES, METHOD FOR PRODUCING THE SAME, METHOD FOR SUPPRESSING STORAGE ODOR OF RAW CHINESE NOODLES, AND AGENT FOR SUPPRESSING STORAGE ODOR OF RAW CHINESE NOODLES

(71) Applicant: NISSIN FOODS HOLDINGS CO., LTD., Osaka-shi Osaka (JP)

(72) Inventors: Naoto ITO, Osaka (JP); Yuji ISHII, Osaka (JP)

(21) Appl. No.: 17/906,835

(22) PCT Filed: Jul. 1, 2021
(86) PCT No.: PCT/JP2021/025025

§ 371 Date: Sep. 20, 2022

(30) Foreign Application Priority Data
Jul. 31, 2020 (JP) 2020-130328

(51) Int. Cl. A23L 7/109; A23L 3/3508

(52) U.S. Cl. CPC A23L 7/109; A23L 3/3508

(57) ABSTRACT

An object of the present invention is to provide raw Chinese noodles in which a storage odor generated in long-term storage at ordinary temperature or in refrigeration is suppressed. This object is achieved by raw Chinese noodles containing sodium tartrate and sodium citrate. The raw Chinese noodles can be produced by adding kneading water having sodium tartrate and sodium citrate and kansui dissolved therein to a main raw material powder, followed by kneading with a mixer to produce a noodle dough, and then subjecting the noodle dough to noodle making. A weight ratio between the sodium tartrate and the sodium citrate contained in the raw Chinese noodles is preferably 1:3 to 3:1, and a content thereof is preferably 2 to 30 g per kg of the main raw material powder.

### TECHNICAL FIELD

The present invention relates to raw Chinese noodles, a method for producing the same, a method for suppressing a storage odor of raw Chinese noodles, and an agent for suppressing a storage odor of raw Chinese noodles.

### BACKGROUND ART

A large number of raw Chinese noodles, which are made from noodle doughs produced by kneading main raw material powders such as wheat flour and kneading water containing kansui are conventionally launched. Some of these are immediately consumed in ramen shops and the like, and the others are chilled raw Chinese noodles having a best-before date of about 1 month under refrigeration at 10° C. or less, and raw Chinese noodles for souvenirs having a best-before date of about 2 months under storage at ordinary temperature owing to drying or a low water content.

Among these, chilled raw Chinese noodles and raw Chinese noodles for souvenirs stored at ordinary temperature give off a more irritant odor as they are stored for a longer period of time, and this odor is conspicuously felt particularly in raw Chinese noodles for souvenirs.

Meanwhile, as a technique for using sodium tartrate or sodium citrate in noodles, Patent Literatures 1 to 3 have been disclosed.

Patent Literature 1 describes, as a method capable of providing noodles and noodle wraps having viscoelasticity and favorable texture, a method for producing noodles or noodle wraps in which an aqueous solution of an organic acid and an organic acid salt of pH 5.6 to 6.0 is used as a moisture used in production of a noodle dough. In the method of Patent Literature 1, however, it is necessary to employ acidic pH for the moisture used in the production of a noodle dough. In producing Chinese noodles containing kansui, the pH of a moisture used in the production of a noodle dough is increased due to kansui, and therefore, the method of Patent Literature 1 is difficult to employ in producing Chinese noodles. Patent Literature 1 does not describe that a storage odor of raw Chinese noodles can be suppressed.

Patent Literature 2 describes, regarding a method for providing a fat or oil composition for a noodle dough and a fat or oil for a noodle dough in which noodles having favorable flavor can be obtained comparatively easily and without modifying the original flavor of noodles, a fat or oil composition for a noodle dough containing 2 ppm by weight to 1500 ppm by weight of at least one organic acid or a salt thereof selected from the group consisting of ascorbic acid, erythorbic acid, lactic acid, tartaric acid, malic acid, and salts thereof. In the method of Patent Literature 2, however, it is necessary to add such an organic acid or an organic acid salt to a noodle dough together with a fat or oil, and hence it is difficult to increase the amount to be added. Patent Literature 2 does not describe that a storage odor of raw Chinese noodles can be suppressed.

Patent Literature 3 describes, regarding a preservative for Chinese noodles having alkaline pH and a method for producing Chinese noodles excellent in storability, a preservative for Chinese noodles containing a basic protein/peptide, glycine, and sodium citrate. The method of Patent Literature 3 aims, however, to suppress the generation of microorganisms and fungi in Chinese noodles, and color change thereof, and does not describe that a storage odor of the raw Chinese noodles can be suppressed.

### CITATION LIST

### Patent Literature

Patent Literature 1: Japanese Patent No. 6523541

Patent Literature 2. Japanese Patent Laid-Open No. 2016-26479

Patent Literature 3: Japanese Patent No. 3002958

### SUMMARY OF INVENTION

### Technical Problem

An object of the present invention is to provide raw Chinese noodles in which a storage odor generated in long-term storage at ordinary temperature or in refrigeration is suppressed.

### Solution to Problem

The present inventors have made earnest studies on a method for suppressing an irritant odor (storage odor) generated in long-term storage of chilled raw Chinese noodles and raw Chinese noodles for souvenirs to be stored at ordinary temperature, resulting in finding the present invention by chance, and thus the present invention was achieved.

Specifically, the present invention provides raw Chinese noodles containing sodium tartrate and sodium citrate.

A weight ratio between the sodium tartrate and the sodium citrate contained in the raw Chinese noodles of the present invention is preferably 1:3 to 3:1, and a total weight content of the sodium tartrate and the sodium citrate is preferably 2 to 30 g per kg of a main raw material powder.

In the raw Chinese noodles of the present invention, a content of the sodium citrate is preferably 1 to 15 g per kg of the main raw material powder.

A method for producing raw Chinese noodles of the present invention preferably includes a step of adding kneading water containing kansui, sodium tartrate and sodium citrate to a main raw material powder, followed by kneading to produce a noodle dough, and a step of subjecting the noodle dough to noodle making by an ordinary method to produce raw noodles.

A method for suppressing a storage odor of raw Chinese noodles of the present invention includes adding sodium tartrate and sodium citrate to raw Chinese noodles.

In addition, an agent for suppressing a storage odor of raw Chinese noodles of the present invention contains sodium tartrate and sodium citrate.

### Advantageous Effect of Invention

According to the present invention, raw Chinese noodles in which a storage odor generated in long-term storage at ordinary temperature or in refrigeration is suppressed can be provided.

### DESCRIPTION OF EMBODIMENT

The present invention will now be described in detail. It is noted that the present invention is not limited to the following description. Raw Chinese noodles of the present invention refers to raw Chinese noodles that have not been subjected to heating process such as steaming or boiling but are stored in refrigeration or at ordinary temperature. The raw Chinese noodles of the present invention encompass what is called semi-dried noodles having been subjected to drying process to have a moisture content of higher than 14% by weight.

1. Noodle Raw Material Formulation

In the raw Chinese noodles of the present invention, raw materials of usual Chinese noodles can be used. Specifically, examples of a main raw material powder include wheat flour, and various starches such as potato starch, tapioca starch, wheat starch, and corn starch, and one of these may be singly used, or a mixture of these may be used. As the starch, raw starch, gelatinized starch, or modified starch such as acetylated starch, etherified starch, or crosslinked starch can be used.

In the present invention, a salt, an alkaline agent such as kansui, various thickeners, gluten, egg white, a noodle quality modifier, an edible fat or oil, various colorants such as carotenoid, a preservative such as an alcohol, which are generally used in production of Chinese noodles, can be added to the main raw material powder. These ingredients may be added in the form of a powder together with the main raw material powder, or may be added after being dissolved or suspended in kneading water. Among these, carbonate such as sodium carbonate or potassium carbonate is preferably used as kansui for imparting flavor peculiar to Chinese noodles and achieving chewy texture, and the carbonate is preferably added in an amount of 1 to 2% by weight to the main raw material powder. In order to increase pH of the noodles to improve the storability, an alkaline agent such as calcined calcium can be added in addition to kansui. The pH of the raw Chinese noodles is preferably 8 to 11. The pH is measured in a suspension obtained by diluting a noodle dough 10 times (in weight). When the pH is too low, the flavor as Chinese noodles is little, and the storability is poor. When the pH is high, although the flavor and the storability are better, a storage odor is strongly generated in long-term storage.

In the raw Chinese noodles of the present invention, sodium tartrate (L sodium tartrate) and sodium citrate (trisodium citrate) are added. These organic acid salts are generally used, in food, as a pH adjuster, an acidifier, a seasoning, or a preservative, but are used in the present invention for purposes of suppressing a storage odor, that is, an irritant odor generated in long-term storage of raw Chinese noodles. Sodium tartrate and sodium citrate are superior to the other organic acid salts in a point that flavor and texture of the raw Chinese noodles are less affected and a storage odor is suppressed. When sodium tartrate or sodium citrate is singly used, however, texture and flavor of raw Chinese noodles are affected, and hence sodium tartrate and sodium citrate are preferably used together. When these are used together, the storage odor can be efficiently suppressed with less affecting texture and flavor.

A weight ratio between sodium tartrate and sodium citrate is preferably 1:3 to 3:1. When the amount of sodium tartrate is increased, texture is affected in long-term storage, and when the amount of sodium citrate is increased, flavor is affected. As for their contents, a total content of sodium tartrate and sodium citrate is preferably about 2 to 30 g per kg of the main raw material powder. In particular, in raw Chinese noodles to be stored in refrigeration, a storage odor is not largely generated, and hence the content is preferably about 2 to 5 g. In raw Chinese noodles to be stored at ordinary temperature, the content is preferably about 10 to 30 g. When sodium citrate is contained in a larger amount, however, the resultant noodles have sourness or bitterness, and hence the content is 15 g or less, and preferably about 1 to 10 g per kg of the main raw material powder. Sodium tartrate and sodium citrate can be precedently mixed with each other to be used as an agent for suppressing a storage odor of raw Chinese noodles.

2. Kneading Step

A method for producing a noodle dough of the present invention may be performed by an ordinary method. Specifically, the main raw material powder and kneading water having kansui and sodium tartrate and sodium citrate dissolved therein may be kneaded to be homogeneously mixed using a batch mixer, a flow jet mixer, a vacuum mixer or the like, and thus, a crumbly dough may be produced.

3. Noodle Making Step

Subsequently, from the thus produced dough, noodle strings are produced. A production method may be performed by an ordinary method, and examples include a method in which the dough is extruded with an extruder or the like to produce noodle strings, and a method in which the dough is formed into a crude noodle belt with a roll, the resultant is formed into a noodle belt by compounding or the like, the resultant is rolled out with a roll plurality of times to obtain a prescribed noodle belt thickness, and the noodle belt is cut with a cutting-out roll designated as a cutting blade to produce noodle strings. When the noodle strings are produced after producing a noodle belt, the noodle belt may be produced with an extruder, and then rolled out and cut, or a noodle belt having a multilayer structure including a plurality of noodle belts may be produced, and then rolled out and cut. When an extruder or the like is used to produce an extruded noodle belt or extruded noodle strings, this process is preferably performed under reduced pressure.

4. Miscellaneous

The raw noodles thus produced are floured if necessary, or dried to reduce moisture content, and then packaged in a bag of polyethylene, polypropylene or the like to obtain chilled raw Chinese noodles to be stored in refrigeration, or raw Chinese noodles to be stored at ordinary temperature. The raw noodles thus packaged in a bag may be put in a bag or a box together with a soup and ingredients to be sold in stores.

The present embodiment will now be more specifically described by way of examples.

### EXAMPLES

### <Experiment 1> Screening Test

With 1 kg of a main raw material powder containing 1000 g of all-purpose flour, 10 g of an egg white powder, 5 g of gluten, and 1.5 g of calcined calcium were mixed. To the resultant, kneading water, which was obtained by dissolving, in 280 g of water, no organic acid salt or 10 g of any of various organic acid salts shown in Table 1 below, 12 g of a kansui preparation (mixture of sodium carbonate and potassium carbonate in a ratio of 6:4), 50 g of a 70% alcohol preparation, 15 g of 60% sodium lactate, 5 g of trehalose, and 1 g of gardenia pigment, was added, and the resultant mixture was kneaded with a normal pressure mixer for 15 minutes to produce a dough.

The thus produced dough was compounded to produce a noodle belt, the noodle belt was matured for 20 minutes, and then rolled out by rolling to a thickness of 1.5 mm, and the resultant noodle belt was cut with a square roll cutting blade No. 16 to obtain noodle strings.

Subsequently, 110 g, corresponding to a single serving size, of the thus produced noodle strings was floured with 4 g of oxidized starch of sago starch, and the resultant was sealed in a polyethylene bag to produce a raw Chinese noodle sample.

Evaluation for an odor felt in opening the bag was performed on the thus produced raw Chinese noodle sample immediately after the production, and after being stored at 40° C. for 1 week as an accelerated aging test. Samples having no organic acid added (Test Example 1), having sodium tartrate added (Test Example 2), having sodium citrate added (Test Example 3), and having sodium malate added (Test Example 4) were also evaluated for an odor felt in opening the bag after storage at 40° C. for 2 weeks or 3 weeks.

Sensory evaluation of an odor felt in opening the bag was performed on kansui odor peculiar to Chinese noodles in samples immediately after the production, and one equivalent to the sample having no organic acid salt added (Test Example 1) was scored as 5, one slightly inferior but good was scored as 4, one substantially acceptable was scored as 3, one inferior was scored as 2, and one greatly inferior was scored as 1. Besides, in the samples after storage at 40° C. for 1 week, 2 weeks or 3 weeks, one that had neither a storage odor (irritant odor) nor an offensive odor excluding the storage odor and hence was very good was scored as 5, one that had slight storage odor and offensive odor and was good was scored as 4, one that had a storage odor or an offensive odor but was substantially acceptable was scored as 3, one that had a storage odor or an offensive odor and was inferior was scored as 2, and one that had a storage odor or an offensive odor and was greatly inferior was scored as 1. It is noted that a storage odor is a pungent irritant odor, and is not a putrid odor caused by microorganisms. None of the samples went bad due to microorganisms. Besides, an offensive odor was defined as an unpleasant odor different from the kansui odor and the storage odor. Evaluation results are shown in Table 1 below.

TABLE 1

| | | | 1 week | 2 weeks | 3 weeks |
|---|---|---|---|---|---|
| Test | Organic | After | at | at | at |
| Example | acid | production | 40° C. | 40° C. | 40° C. |
| 1 | Not added | 5 | 3 | 2 | 1 |
| 2 | Sodium tartrate | 5 | 4 | 4 | 3 |
| 3 | Sodium citrate | 5 | 4 | 4 | 3 |
| 4 | Sodium malate | 5 | 4 | 3 | 2 |
| 5 | Sodium fumarate | 3 | 3 | — | — |
| 6 | Sodium acetate | 3 | 3 | — | — |

As shown in Table 1, when no organic acid salt was added (Test Example 1), an irritant odor corresponding to a storage odor was strongly felt in a storage test at 40° C. for 1 week, and an intense irritant odor was felt in a storage test at 40° C. for 3 weeks. On the contrary, in experimental plots of adding sodium tartrate (Test Example 2), sodium citrate (Test Example 3), and sodium malate (Test Example 4), the storage odor was suppressed in the storage tests at 400 for 1 to 3 weeks as compared with that in Test Example 1 without affecting flavor of noodles obtained immediately after the production. In using sodium malate, however, an offensive odor like a chemical odor started to be felt after storage at 40° C. for 2 weeks, and the chemical odor was rather strongly felt in the storage test at 40° C. for 3 weeks. In using sodium fumarate (Test Example 5) and sodium acetate (Text Example 6), the kansui odor peculiar to Chinese noodles immediately after the production was weakened, and in the storage test at 40° C. for 1 week, a storage odor equivalent to that generated with no organic acid salt added was generated in using sodium fumarate, and a storage odor was not felt but an offensive odor like an odor of shrimps was generated in using sodium acetate. Based on these results, it was decided to further examine sodium tartrate and sodium citrate.

### <Experiment 2> Examination on Sodium Tartrate and Sodium Citrate

Based on the results of Experiment 1, sodium tartrate and sodium citrate were further examined. In accordance with formulations of organic acid salts shown in Table 2, raw Chinese noodle samples were produced in accordance with the method of Experiment 1. The thus produced samples were subjected to a storage test at 40° C. for 1 week, 2 weeks or 3 weeks as an accelerated aging test, and evaluated for an odor felt in opening the bag in the same manner as in Experiment 1.

Besides, in Experiment 2, each sample was cooked, and flavor and texture of the noodles were also evaluated. As a cooking method, each raw Chinese noodle sample was put in 1500 ml of boiling water to be boiled for 3 minutes, hot water was drained, and then the boiled Chinese noodle sample was put in a precedently prepared soy-source ramen soup to be eaten for evaluation. A sample having no organic acid salt added (Test Example 1) immediately after production was used as a reference, and equivalent one was scored as 5, rather inferior but good one was scored as 4, inferior but substantially acceptable one was scored as 3, inferior one was scored as 2, and greatly inferior one was scored as 1. As for the flavor, only a sample obtained immediately after the production was evaluated. Evaluation results are shown in Table 2 below.

TABLE 2

| | Sodium tartrate | Sodium citrate | | | | | | | | | |
|---|---|---|---|---|---|---|---|---|---|---|---|
| Test | (g/kg of main raw | (g/kg of main raw | After production | | | 1 week at 40° C. | | 2 weeks at 40° C. | | 3 weeks at 40° C. | |
| Example | material powder) | material powder) | Odor | Flavor | Texture | Odor | Texture | Odor | Texture | Odor | Texture |
| 1 | 0 | 0 | 5 | 5 | 5 | 3 | 3 | 2 | 2 | 1 | 1 |
| 7 | 20 | 0 | 5 | 5 | 3 | 4 | 3 | 3.5 | 2 | 3 | 1 |
| 8 | 15 | 5 | 5 | 5 | 4 | 4.5 | 4 | 4 | 3 | 3 | 2 |
| 9 | 10 | 10 | 5 | 5 | 5 | 5 | 5 | 4 | 4 | 4 | 4 |
| 10 | 5 | 15 | 5 | 4 | 4 | 5 | 4 | 4 | 4 | 4 | 4 |
| 11 | 0 | 20 | 5 | 3 | 3 | 5 | 3 | 4 | 3 | 4 | 3 |
| 12 | 5 | 5 | 5 | 5 | 5 | 4 | 4 | 4 | 3 | 3 | 2 |
| 13 | 15 | 15 | 5 | 4 | 5 | 5 | 5 | 4.5 | 4 | 4 | 4 |

As shown in Table 2, in Test Example 7 in which sodium tartrate alone was added, an odor and flavor immediately after the production were not affected, but texture was softened. Besides, in a storage test at 40° C., an odor of alcohol added was not felt in the first week of the storage test, but became conspicuous in and after the second week. As for the texture, similarly to Test Example 1 having no organic acid salt added, as the storage period was longer, the texture became more brittle and easy-to-break.

In Test Example 11 having sodium citrate alone added, an odor immediately after the production was not affected, but the noodles had sourness and bitterness, and the texture was rather hard. As the storage period was longer, a storage odor was more favorably suppressed, and the texture was little changed.

On the contrary, in experimental plots 8 to 10 in which sodium tartrate and sodium citrate were used in combination, the texture and flavor immediately after the production were more than favorable, and even after usual storage at 40° C. for 1 week, the odor and the texture were both more than favorable. Accordingly, it was suggested that using sodium tartrate and sodium citrate in combination within a range from 1:3 to 3:1 is preferable.

In addition, as in Test Examples 12 and 13, when the amount of sodium tartrate and sodium citrate to be added was small, the ability to suppress the generation of a storage odor and texture deterioration over time was weakened, and on the contrary, when the amount was too large, the flavor of sodium citrate was felt. Accordingly, it is presumed that the amount of sodium citrate to be added is 15 g or less, more preferably 10 g or less per kg of the main raw material powder. Besides, it is presumed that a total amount of sodium tartrate and sodium citrate to be added is preferably 30 g or less per kg of the main raw material powder.

### <Experiment 3> Examination on Chilled Raw Chinese Noodles

In accordance with formulations shown in Table 3 below, raw Chinese noodle samples were produced in accordance with the method of Experiment 1, and stored in a thermostatic chamber at 10° C. for 30 days. Immediately after the production, storage test samples were evaluated for an odor, texture, and flavor in the same manner as in Experiment 2. Evaluation results are shown in Table 3 below.

TABLE 3

| | Sodium tartrate | Sodium citrate | | | | | |
|---|---|---|---|---|---|---|---|
| Test | (g/kg of main raw | (g/kg of main raw | After production | | | 30 days at 10° C. | |
| Example | material powder) | material powder) | Odor | Flavor | Texture | Odor | Texture |
| 1 | 0 | 0 | 5 | 5 | 5 | 4 | 4 |
| 12 | 5 | 5 | 5 | 5 | 5 | 5 | 5 |
| 14 | 1 | 1 | 5 | 5 | 5 | 5 | 5 |

As shown in Table 3, in Test Example 1 having no organic acid salt added, a storage odor was reduced in storage in refrigeration as compared with that generated in the accelerated aging test of Experiment 2, but an odor was generated. On the contrary, as in Test Examples 12 and 14, a storage odor is suppressed by adding sodium tartrate and sodium citrate, and in addition, texture deterioration (brittleness) was also suppressed. As in Test Examples 12 and 14, the effect was not largely changed even when the amount to be added was increased, and it is presumed that the effect of suppressing a storage odor can be sufficiently obtained when sodium tartrate and sodium citrate are added, in the chilled raw Chinese noodles, in a total amount of 2 g or more per kg of the main raw material powder.

1. Raw Chinese noodles, comprising sodium tartrate and sodium citrate.

2. The raw Chinese noodles according to claim 1, wherein a weight ratio between the sodium tartrate and the sodium citrate contained in the raw Chinese noodles is 1:3 to 3:1, and wherein a total weight content of the sodium tartrate and the sodium citrate is 2 to 30 g per kg of a main raw material powder.

3. The raw Chinese noodles according to claim 1, wherein a content of the sodium citrate is 1 to 15 g per kg of a main raw material powder.

4. A method for producing raw Chinese noodles, comprising:
a step of adding kneading water containing kansui, sodium tartrate and sodium citrate to a main raw material powder, followed by kneading to produce a noodle dough, and
a step of subjecting the noodle dough to noodle making by an ordinary method to produce raw noodles.

5. (canceled)

6. An agent for suppressing a storage odor of raw Chinese noodles, comprising sodium tartrate and sodium citrate.

7. The raw Chinese noodles according to claim 2, wherein a content of the sodium citrate is 1 to 15 g per kg of a main raw material powder.
